(19) United States
(12) Patent Application Publication
(10) Pub. No.: US 2016/0171267 A1
(43) Pub. Date: Jun. 16, 2016

(54) SCANNING DEVICE

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventor: QIAO-ZHONG LI, Shenzhen (CN)

(21) Appl. No.: 14/584,709

(22) Filed: Dec. 29, 2014

(30) Foreign Application Priority Data
Dec. 10, 2014 (CN) 201410750549.2

(51) Int. Cl. G06K 7/10

(52) U.S. Cl. CPC G06K 7/10831

(57) ABSTRACT

A scanning device includes a supporting table and a scanner for scanning a barcode on a merchandise. The supporting table includes a supporting surface configured to support the merchandise and a mirror mounted in the mounting slot. An image of the barcode can be defined in the mirror to be slanted with a top surface of the mirror, and the scanner is configured to scan the image.

### CROSS-REFERENCE TO RELATED APPLICATIONS

This Application claims priority to Chinese Patent Application No. 201410750549.2 filed on Dec. 10, 2014, the contents of which are hereby incorporated by reference.

### FIELD

The subject matter herein generally relates to a scanning device, and more particularly to a scanning device which can be used for quickly scanning a barcode.

### BACKGROUND

A barcode is generally printed for merchandise. Users can scan the bar code with a scanning device to obtain information regarding the merchandise.

### BRIEF DESCRIPTION OF THE DRAWINGS

Implementations of the present technology will now be described, by way of example only, with reference to the attached figures.

FIG. 1 is an exploded, isometric view of a scanning device in accordance with an embodiment.

FIG. 2 is an assembled, isometric view of the scanning device of FIG. 1.

FIG. 3 is a cross-sectional view of FIG. 2, taken along a line III-III, in which a barcode faces a scanner.

FIG. 4 is similar to FIG. 3, in which the barcode faces a mirror.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

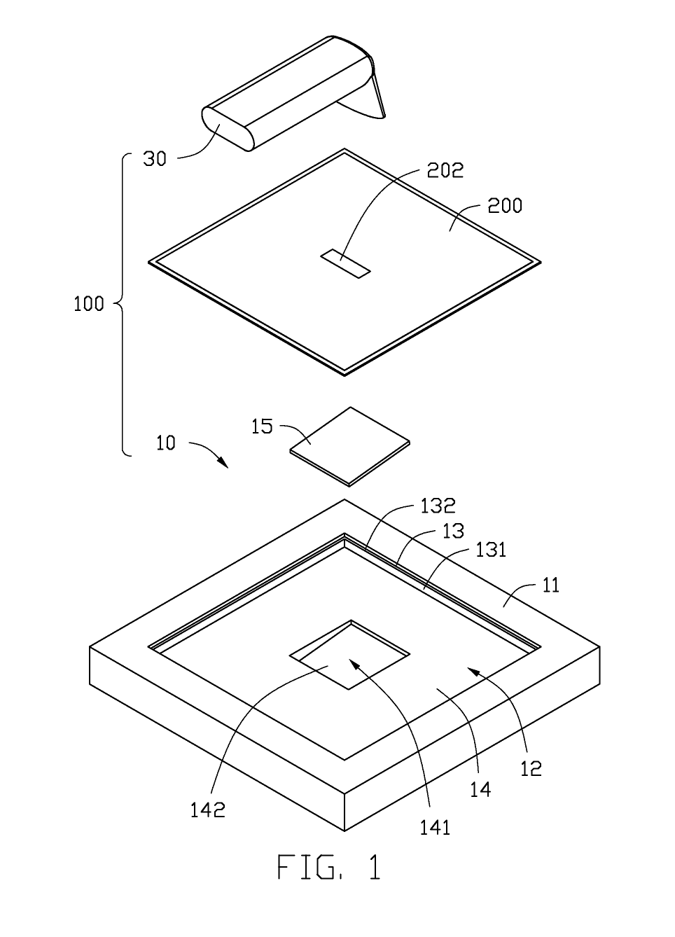

FIG. 1 illustrates a scanning device 100 for scanning a barcode 202 printed on merchandise 200. The scanning device 100 can include a supporting table 10 configured to place the merchandise 200 and a scanner 30 configured to scan the barcode 202. In at least one embodiment, the merchandise 200 is transparent, such as a liquid crystal display.

The supporting table 10 can include a top surface 11 and defines a receiving slot 12. The receiving slot 12 extends from the top surface 11. In at least one embodiment, the receiving slot 12 is substantially a square and has a bottom wall 14 and four sidewalls 13 perpendicular to the bottom wall 14.

A protruding portion 131 extends from the sidewalls 13, and is connected to the bottom wall 14. The protruding portion 131 can include a supporting surface 132 located at a top end of the protruding portion 131. The supporting surface 132 is a horizontal plane. The supporting surface 132 is lower than the top surface 11 in a vertical direction. In at least one embodiment, the supporting surface 132 is substantially parallel with the top surface 11.

A mounting slot 141 is defined in the bottom wall 14. The mounting slot 141 is substantially square and located at the center of the bottom wall 14. The mounting slot 141 has a mounting wall 142. The mounting wall 142 is an inclined plane. An acute angle is defined between the mounting wall 142 and the supporting surface 132.

The supporting table 10 can further include a mirror 15. The mirror 15 is configured to reflect the barcode 202 on the merchandise 200.

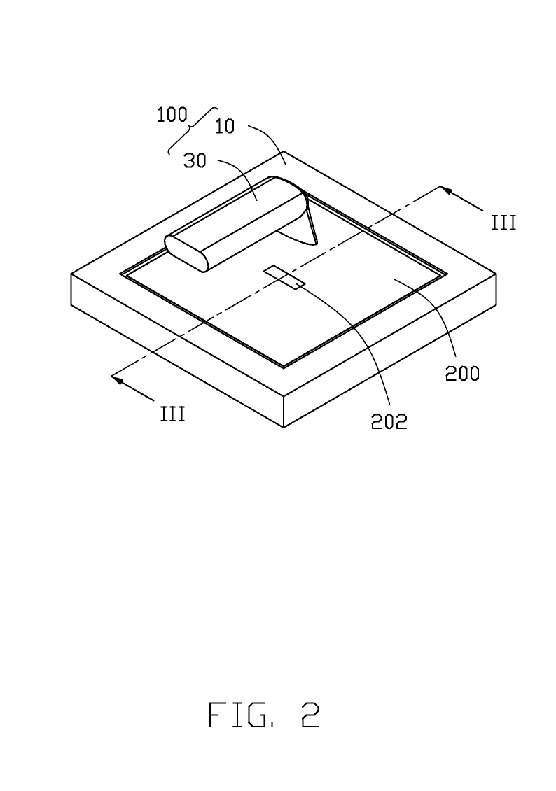

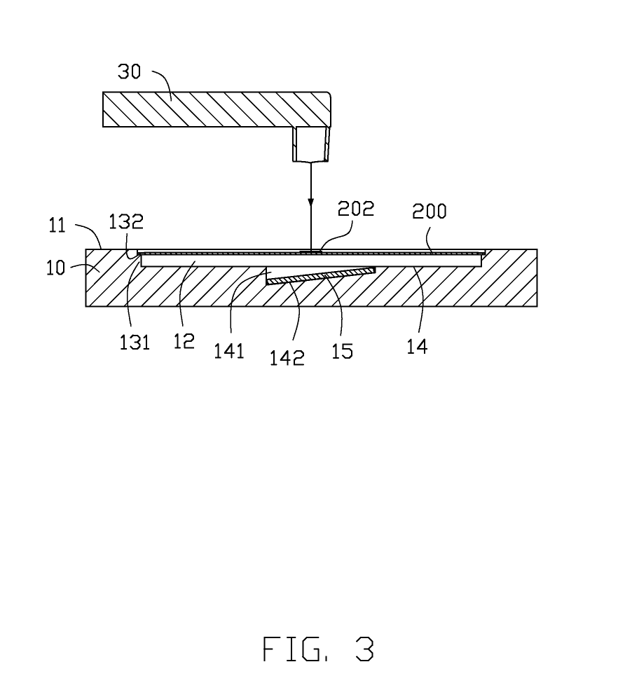

FIGS. 2 to 3 illustrate an assembly of the scanning device 100, wherein the barcode 202 on the merchandise 200 faces the scanner 30. The mirror 15 is located in the mounting slot 141 and mounted on the mounting wall 142. The mirror 15 is spaced from the supporting surface 132. An acute angle is defined between the mirror 15 and the supporting wall 132.

The merchandise 200 is placed on the supporting surface 132 of the supporting table 10. A user can use the scanner 30 to scan the barcode 202 on the merchandise 200 when the barcode 202 faces the scanner 30.

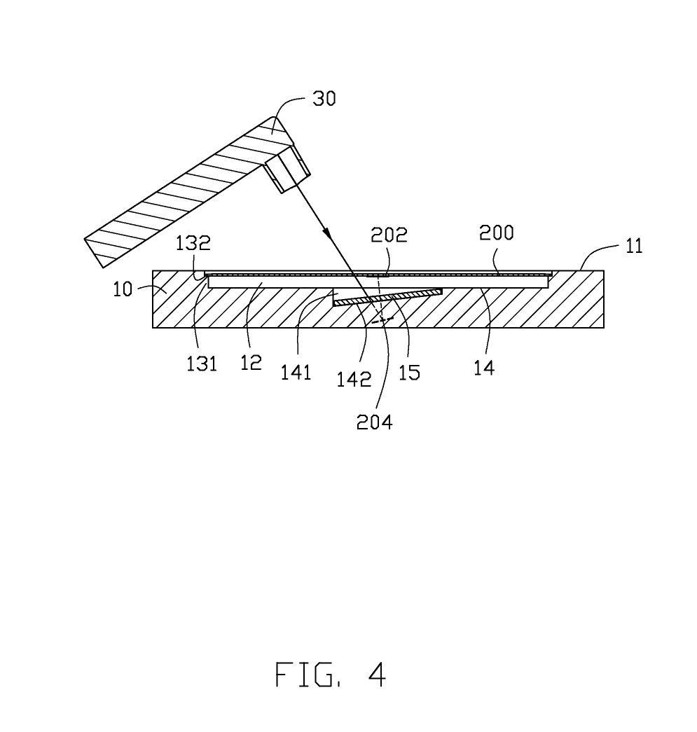

FIG. 4 illustrates an assembly of the scanning device 100, wherein the barcode 202 on the merchandise 200 is back to the scanner 30. The barcode 202 on the merchandise 200 faces the mirror 15. An acute angle is defined between the merchandise 200 and the mirror 15. A barcode image 204 is defined in the mirror 15 to be slanted with a top surface of the mirror 15, thereby being convenient for the scanner 30 to scan the barcode image 204. In at least one embodiment, the scanner 30 can scan the barcode image 204 through the merchandise 200 when the merchandise 200 is transparent.

The scanner 30 can scan the barcode 202 on the merchandise 200 when the barcode 202 faces the scanner 30. The scanner 30 can scan the barcode image formed in the mirror 15 when the barcode 202 is back to the scanner 30. The user does not need to rotate the merchandise 200 to make the barcode 202 face the scanner 30 in a process of scanning, thereby being convenient for the user to scan the barcode 202 on the merchandise 200.

The embodiments shown and described above are only examples. Many details are often found in the art such as the other features of a scanning device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A scanning device comprising:
a scanner configured to scan a barcode on a merchandise; and
a supporting table defining a mounting slot, comprising:
a supporting surface configured to place the merchandise; and
a mirror mounted in the mounting slot;
wherein an image of the barcode is configured to be defined in the mirror to be slanted with a top surface of the mirror, and the scanner is configured to scan the image.

2. The scanning device of claim 1, wherein the mirror is slanted relative to the supporting surface.

3. The scanning device of claim 1, wherein an acute angle is defined between the supporting surface and the mirror.

4. The scanning device of claim 1, wherein the supporting table defines a receiving slot, the receiving slot comprises a sidewall, a protruding portion extends from the sidewall, and the supporting surface is located at a top end of the protruding portion.

5. The scanning device of claim 4, wherein the supporting surface is a horizontal plane.

6. The scanning device of claim 4, wherein the supporting table comprises a top surface, the receiving slot extends from the top surface, and the supporting surface is lower than the top surface in a vertical direction.

7. The scanning device of claim 4, wherein the receiving slot further comprises a bottom wall perpendicular to the sidewall, the mounting slot is defined in the bottom wall.

8. The scanning device of claim 7, wherein the mounting slot comprises a mounting wall, an acute angle is defined between the mounting wall and the supporting surface, and the mirror is mounted on the mounting wall.

9. The scanning device of claim 7, wherein the mounting slot is located at the center of the bottom wall.

10. The scanning device of claim 7, wherein the protruding portion is connected to the bottom wall.

11. A scanning device comprising:
a scanner configured to scan a barcode on a merchandise; and
a supporting table defining a mounting slot, comprising:
a supporting surface configured to place the merchandise; and
a mirror mounted in the mounting slot;
wherein the mirror is spaced with the supporting surface, an image of the barcode is configured to be defined in the mirror, and the scanner is configured to scan the image.

12. The scanning device of claim 11, wherein the supporting table defines a receiving slot, the receiving slot comprises a bottom wall spaced with the supporting surface, the mounting slot is defined in the bottom wall.

13. The scanning device of claim 12, wherein the mounting slot is located at the center of the bottom wall.

14. The scanning device of claim 12, wherein the receiving slot further comprises a sidewall perpendicular to the bottom wall, a protruding portion extends from the sidewall, and the supporting surface is located at a top of the protruding portion.

15. The scanning device of claim 12, wherein the supporting surface is a horizontal plane.

16. The scanning device of claim 12, wherein the supporting table comprises a top surface, the receiving slot extends from the top surface, and the supporting surface is lower than the top surface in a vertical direction.

17. A scanning device comprising:
a scanner configured to scan a barcode on a merchandise; and
a supporting table defining a mounting slot, comprising:
a supporting surface configured to place the merchandise; and
a mirror mounted in the mounting slot;
wherein the mirror is slanted and spaced with the supporting surface, an image of the barcode is configured to defined in the mirror to be slanted with a top surface of the mirror, thereby the image is configured to be scanned by the scanner.

18. The scanning device of claim 17, wherein an acute angle is defined between the supporting surface and the mirror.

19. The scanning device of claim 17, wherein the supporting table defines a receiving slot, the receiving slot comprises a bottom wall spaced with the supporting surface, the mounting slot is defined in the bottom wall.

20. The scanning device of claim 19, wherein the supporting table comprises a top surface, the receiving slot extends from the top surface, and the supporting surface is lower than the top surface in a vertical direction.
